(19) United States
(12) Patent Application Publication
(10) Pub. No.: US 2014/0254891 A1
(43) Pub. Date: Sep. 11, 2014

(54) METHOD AND APPARATUS FOR REGISTERING FACE IMAGES, AND APPARATUS FOR INDUCING POSE CHANGE, AND APPARATUS FOR RECOGNIZING FACES

(71) Applicant: SUPERMA INC., Seongnam-si (KR)

(72) Inventors: Ki Deok LEE, Seongnam-si (KR); Bo Gun PARK, Seongnam-si (KR); Bong Seop SONG, Seongnam-si (KR); Jae Won LEE, Seongnam-si (KR)

(73) Assignee: SUPERMA INC., Seongnam-si (KR)

(21) Appl. No.: 14/140,315

(22) Filed: Dec. 24, 2013

(30) Foreign Application Priority Data
Mar. 8, 2013 (KR) 10-2013-0025274

(51) Int. Cl. G06K 9/00

(52) U.S. Cl. CPC G06K 9/00261; G06K 9/00288
USPC 382/118

(57) ABSTRACT

A face image registration apparatus comprising: a face video image acquiring unit configured to acquire a front face image and at least one or more moving video images corresponding to predefined face pose changes; a similarity measurement unit configured to measure a similarity of the acquired front face image and each of the acquired at least one or more moving video images; an image selection unit configured to select at least images from the at least one or more moving video images based on the measured similarities;

and an image storage unit configured to store the selected at least one or more images on the user basis.

### RELATED APPLICATIONS

This application claims the benefit of Korean Patent Application No. 10-2013-0025274, filed on Mar. 8, 2013, which is hereby incorporated by reference as if fully set forth herein.

### FIELD OF THE INVENTION

The present invention relates to face recognition technology, and more particularly, to an apparatus and method for registering face images, an apparatus for inducing a change in a face pose, and an apparatus for recognizing faces.

### BACKGROUND OF THE INVENTION

Typically, a face recognition system refers to a system that automatically identifies the user based on a digital image by comparing face features extracted from the digital image and face database. Representative applications of the face recognition system may be personal identification system such as credit cards, driver's licenses, passports, access control systems, security systems, and the like.

Meanwhile, a face pose change is one of important factors to greatly degrade performance of the face recognition system when performing face recognition. A typical face recognition system makes the users correct pose themselves so that it can recognize the front faces of the users in order to secure recognition performance. Further, if the face recognition system is moved to another location, it is difficult for the user to take the same pose as that taken at the time of registering the face image of the user, which results in reduced recognition performance.

For example, a system and method for recognizing a face based on pose estimation are disclosed in Korean Registered Patent No. 101133225. The system classifies face images into groups for different poses to store them, estimates a pose of an input face image when detecting the face image, and compares the similarity between the input face image and data in the respective groups, thereby reducing the amount of computations and improving face recognition speed. However, according to the aforementioned system, resource consuming process is required due to a complicated computation to estimate the face pose in the input face image and recognition accuracy cannot be secured. In addition, since the system stores the face images on a pose basis, if it fails to estimate the face pose during the face recognition, it should carry out the similarity test to another face pose, which causes a recognition failure to reduce recognition performance.

### SUMMARY OF THE INVENTION

In view of the above, the present invention provides an apparatus and method for registering face images, an apparatus for inducing a change in a face pose, and an apparatus for recognizing faces that are capable of improving face recognition performance, by inducing the change in a face pose to acquire a plurality of moving video images and storing some or all of the moving video images on the user basis based on the similarity to a front face image to utilize a face recognition technique.

In accordance with a first embodiment of the present invention, there is provided a face image registration apparatus comprising: a face video image acquiring unit configured to acquire a front face image and one or more moving video images corresponding to predefined face pose changes; a similarity measurement unit configured to measure a similarity of the acquired front face image and each of the acquired one or more moving video images; an image selection unit configured to select images from the one or more moving video images based on the measured similarities; and an image storage unit configured to store the selected one or more images on the user basis.

In the embodiment, the image selection unit is configured to select a preset number of images having high similarity in order.

In the embodiment, the image selection unit is configured to select one or more images from the acquired one or more moving video images based on the measured similarities and the face visibility in the respective images.

In the embodiment, a face image registration apparatus further comprising: a pose change determination unit configured to determine the face pose change based on the acquired one or more moving video images; and a control unit configured to produce a control signal so that the face image acquisition unit can reacquire another front face image or one or more moving video images when the acquired front face image or the acquired moving video images do not have the predefined face pose changes.

In accordance with a second embodiment of the present invention, there is provided a face image registration method comprising: acquiring a front face image and one or more moving video images corresponding to face pose changes; measuring a similarity of the acquired front face image and each of the required one or more moving video images; selecting one or more images from the one or more moving video images based on the measured similarities; and storing the selected one or more images on the user basis.

In the embodiment, said selecting one or more images comprising: selecting a preset number of images having high similarity in order.

In the embodiment, said selecting one or more images comprising: selecting one or more images from the acquired one or more moving video images based on the measured similarities and the face visibility in the respective images.

In the embodiment, the face image registration method further comprising: determining the face pose change based on the acquired one or more moving video images; and producing a control signal to reacquire another front face image or one or more moving video images when the acquired front face image or the acquired moving video images do not have the predefined face pose changes.

In accordance with a third embodiment of the present invention, there is provided an apparatus for inducing a pose change for face image registration, the apparatus comprising: a guiding signal producing unit configured to produce a guiding signal to induce the pose change of a user corresponding to predefined pose changes; and a guiding signal provision unit configured to provide the produced guiding signal to the user as output.

In accordance with a fourth embodiment of the present invention, there is provided an apparatus for recognizing face images, the apparatus comprising: a pose change inducing module configured to produce a guiding signal for inducing a face pose change of the user and to provide it to the user; a face registration module configured to acquire one or more moving video images depending on the face pose change of the user, measure the similarity to a front face image of the user, select one or more images from the acquired moving video images based on the measured similarity, and store the selected moving video images on the user basis; and a face recognition module configured to compare a face image which is subjected to face recognition with each of the moving video images on the user basis stored in the face registration module to perform the face recognition.

### BRIEF DESCRIPTION OF THE DRAWINGS

The above and other objects and features of the present invention will become apparent from the following description of the embodiments given in conjunction with the accompanying drawings, in which:

FIG. 1 is a schematic block diagram of a face recognition apparatus in accordance with an embodiment of the present invention;

FIG. 2 is a detailed block diagram of the pose change inducing module shown in FIG. 1;

FIG. 3 is a detailed block diagram of the face image registration module shown in FIG. 1;

FIG. 4 is an exemplary view illustrating the face pose changes in accordance with an embodiment of the present invention;

FIGS. 5A and 5B are views illustrating examples of inducing the face movement of the user in accordance with an embodiment of the present invention; and

FIG. 6 is a flowchart illustrating a face image registration method in accordance with an embodiment of the present invention.

### DETAILED DESCRIPTION OF THE EMBODIMENTS

Hereinafter, the embodiments of the present invention will be described in detail with reference to the accompanying drawings. In the following description, well-known functions or constitutions will not be described in detail if they would unnecessarily obscure the gist of the embodiments of the invention. Further, the terminologies to be described across the specification are defined in consideration of their functionality and may vary depending on a user's or operator's intention or practice. Accordingly, the definition of the terminologies may be made on the basis of the content throughout the specification.

The term of a still video image used herein refers to an image captured during no motion of the face, the term of a back-forth moving video image refer to an image captured during back and forth head movements, the term of a left-right moving video image refer to an image captured during left and right head movements, and the term of an up-down moving video image refers to an image captured during up and down head movements.

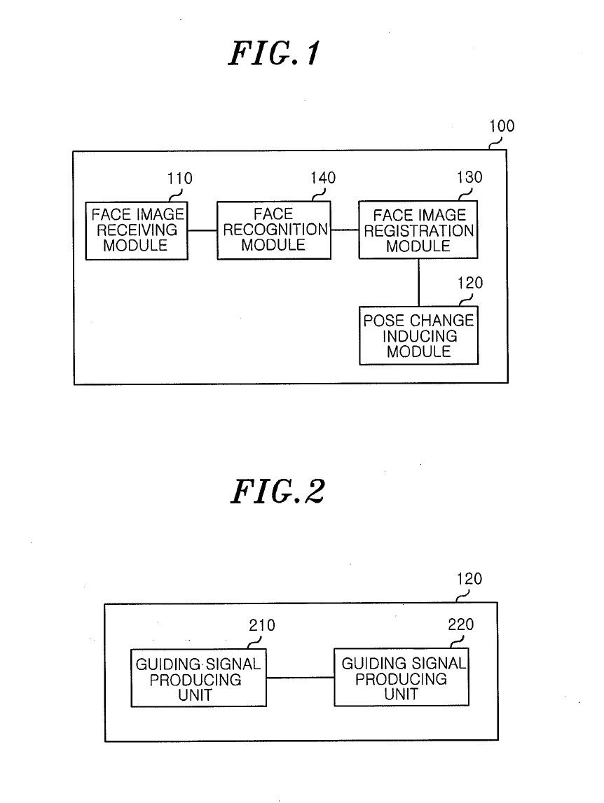

FIG. 1 is a schematic block diagram of a face recognition apparatus in accordance with an embodiment of the present invention.

Referring to FIG. 1, a face recognition apparatus 100 in accordance with an embodiment of the present invention includes a face image receiving module 110, a pose change inducing module 120, a face image registration module 130 and a face recognition module 140.

The face image receiving module 110 receives face images of the user who is subjected to face recognition.

The pose change inducing module 120 produces a guiding signal for inducing a face pose change of the user. Detailed description on the pose change inducing module 120 will be made with reference to FIG. 2 later.

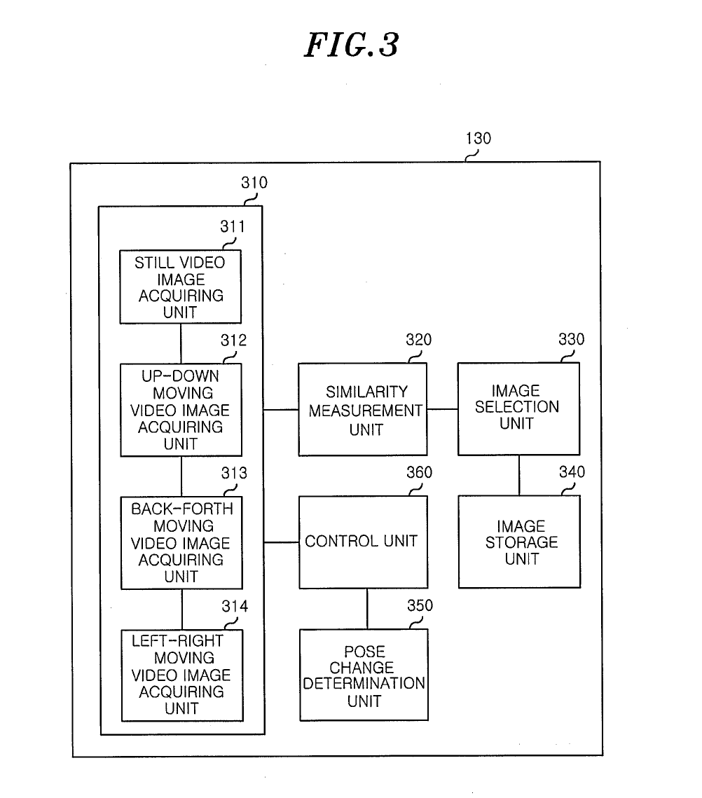

The face registration module 130 acquires one or more moving video images depending on a face pose change of the user; measures the similarity to a front face image of the user; selects one or more images from the acquired moving video images based on the measured similarity; and stores the selected moving video images on the user basis. Detailed description about the pose change inducing module 120 will be made with reference to FIG. 3 later.

The face recognition module 140 compares the face image received via the face image receiving module 110 with each of the moving video images on the user basis stored to perform the face recognition. For example, the face recognition module 140 compares the face image received via the face image receiving module 110 with the moving video images on the user basis stored in the face image registration module 130 to measure the similarity therebetween, thereby recognizing the face of the user. During the face recognition, the similarity measurement may employ the Dot product calculation.

FIG. 2 is a detailed block diagram of the pose change inducing module 120 shown in FIG. 1.

Referring to FIG. 2, the pose change inducing module 120 includes a guiding signal producing unit 210 and a guiding signal providing unit 220.

The guiding signal producing unit 210 produces a guiding signal to induce the pose change of the user corresponding to a predefined pose change. For example, in the case where the predefined pose change is the up and down face movements of the user, the guiding signal producing unit 210 produces a guiding signal to induce the up and down face movements of the user. In this connection, the guiding signal may be a video signal, a voice signal, or the like but is not limited thereto and may include any signals suitable for inducing the pose change of the user.

The guiding signal providing unit 220 provides the guiding signal that is produced by the guiding signal producing unit 210 to the user as an output. For example, in the case where the guiding signal includes the video signal, the guiding signal providing unit 220 outputs the guiding signal as a video, and in the case where the guiding signal includes the voice signal, the guiding signal providing unit 220 outputs the guiding signal as voice. Further, when the guiding signal includes the combination of the video and voice signals, the guiding signal providing unit 220 outputs the guiding signal as both image and voice at the same time.

FIG. 3 is a detailed block diagram of the face image registration module 130 shown in FIG. 1.

Referring to FIG. 3, the face image registration module 130 includes a face image acquiring toolbox 310, a similarity measurement unit 320, an image selection unit 330, and an image storage unit 340.

The face image acquiring toolbox 310 acquires the front face image and the moving video images corresponding to the face pose change. To do it, the face image acquiring toolbox 310 includes a still video image acquiring unit 311, an up-down moving video image acquiring unit 312, a back-forth moving video image acquiring unit 313 and a left-right moving video image acquiring unit 314.

The still video image acquiring unit 311 acquires a still video image of the face and then acquires the front face image from the still video image.

The up-down moving video image acquiring unit 312 acquires the up-down moving video image corresponding to the up-down face movement, the back-forth moving video image acquiring unit 313 acquires the back-forth moving video image corresponding to the back-forth face movement, the left-right moving video image acquiring unit 314 acquires the left-right moving video image corresponding to the left-right face movement. The still video image acquiring unit 311, the up-down moving video image acquiring unit 312, the back-forth moving video image acquiring unit 313, and the left-right moving video image acquiring unit 314 may acquire their related moving video images corresponding to the respective face movements by capturing the face of the user for a preset time or capturing the face of the user by a preset number of times. While the embodiment of the present invention has described the back-forth moving video image, the up-down moving video image, and left-right moving video image as examples of the moving video images, the embodiment of the present invention is not limited thereto and may include any moving video images corresponding to movements in different directions depending on system performance and the purpose and utilization type of the present invention.

The similarity measurement unit 320 measures the similarity of the front face image acquired by the face image acquiring toolbox 310 and each of the moving video images corresponding to the face pose change.

The image selection unit 330 selects one or more images from the moving video images acquired by the face image acquiring toolbox 310 based on the measured similarities by the similarity measurement unit 320. For example, the image selection unit 330 may select a preset number of images having high similarity in order. If necessary, the image selection unit 330 may select the moving video images in consideration of a face size, visibility, or the like, in addition to the similarity.,

The image storage unit 340 stores the moving video images selected by the image selection unit 330 and the front face images acquired by the image selection unit 330 for different users.

Further, in accordance with an additional embodiment of the present invention, the face image registration module 130 further includes a pose change determination unit 350 and a control unit 360.

The pose change determination unit 350 determines a face pose change based on the still video image or the moving video images acquired by the face image acquiring toolbox 310. For example, assuming that the up-down moving video image acquiring unit 312 acquires the up-down moving video images, the pose change determination unit 350 can determine the face pose change based on the up-down moving video images acquired by the up-down moving video image acquiring unit 312. There are several methods for determining the face pose change, for example, such as a method in which feature points are extracted from the eye, nose, mouth, and the like of the face in the respective moving video images, a face pose is estimated based on the correlation of the feature points, and a full face movement is determined through the pose estimation of the respective moving video images and a method in which feature points such as end points of an eye, nose, mouth, and the like of the face in the respective moving video images are traced to determine a face movement. However, these methods are merely examples and the method is not limited thereto.

The control unit 360 controls the face image acquiring toolbox 310 to reacquire the front video image (or front face image) and the moving video images, when they are not fallen within the predefined pose change as the determination result of the pose change determination unit 350.

For example, when it is determined that the face pose change in the acquired still video image does not the predefined motionless state, the control unit 360 controls the still video image acquiring unit 311 to require the still video image. Also, when it is determined that the face pose change in the acquired up-down moving video image does not the preset up-down movement (i.e., another movement except the up-down movement is included in the acquired respective images, other than the up-down movement), the control unit 360 controls the up-down moving video image acquiring unit 312 to reacquire the up-down moving video image. Also, when it is determined that the face pose change in the acquired back-forth moving video image do not the preset back-forth movement, the control unit 360 controls the back-forth moving video image acquiring unit 313 to reacquire the back-forth moving video image. Also, when it is determined that the face pose change in the acquired left-right moving video image does not the preset left-right movement, the control unit 360 controls the left-right moving video image acquiring unit 314 to reacquire the left-right moving video image.

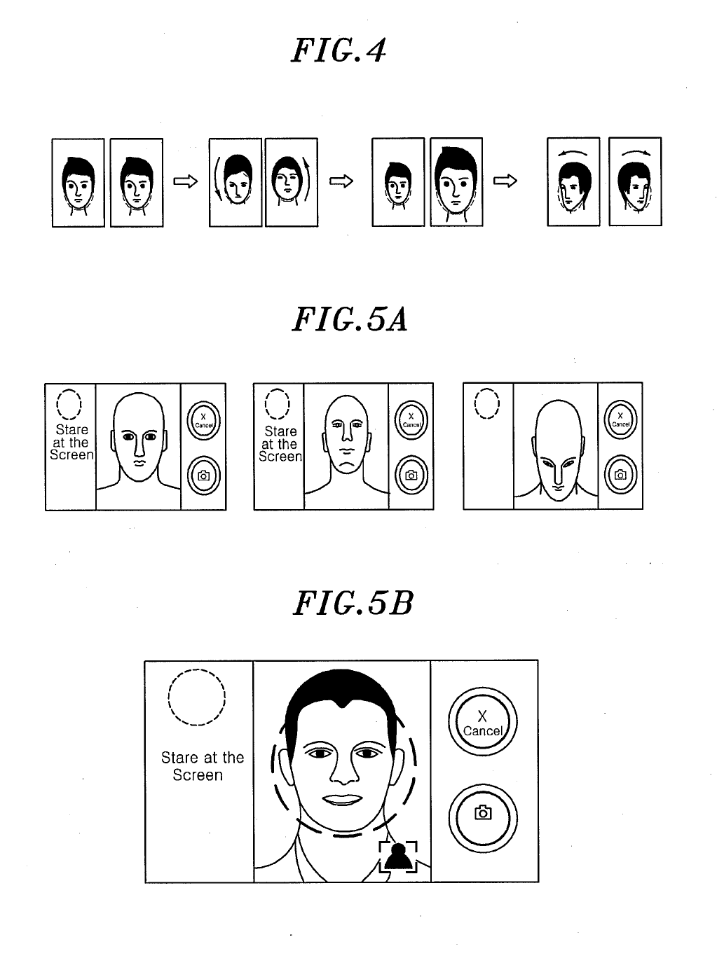

FIG. 4 is an exemplary view illustrating the face pose change in accordance with an embodiment of the present invention.

Referring to FIG. 4, the user may change his/her face pose in the motionless state without any face movement, the up-down movement state to move the face (or to node his/her head) in up and down directions, the back-forth movement state to move the face in back and forth directions, and the left-right movement state to move the face (or to shake his/her head) in left and right directions. Although FIG. 4 illustrates the face pose change varying the motionless, the up-down, back-forth and left-right movements in order, but is not limited thereto, and the sequence of the face pose change may be changed.

FIGS. 5A and 5B are views illustrating examples of inducing the face movement of the user in accordance with an embodiment of the present invention. More specifically, FIG. 5A illustrates a screen example displaying the guide video to induce the up-down head movement of the user in order to acquire the up-down moving video image and FIG. 5B illustrates a screen example showing the face of the user so as to monitor the movement of the user after outputting the guide video.

Referring to FIG. 5A, the guide video to induce the up-down head movement of the user may be configured as an animation representing the pose change, but is not limited thereto, and may be implemented in various ways.

While FIG. 5A illustrates an example of the guide video to induce the up-down head movement, the pose inducing unit 120 can produce different guide videos to induce the left-right movement, back-forth movement and freeze motion and outputs them. In addition, depending on system performance and the purpose and utilization type of the present invention, if it is intended to acquire moving video images reflecting various face pose changes, it may be possible to provide guide videos to induce such movements.

Referring to FIG. 5B, there is shown a face of the user so that the user can monitor the movement of the user after outputting the guide video. Based on the monitoring, the user may move in accordance with the guide video provided to the user and monitor his/her movement.

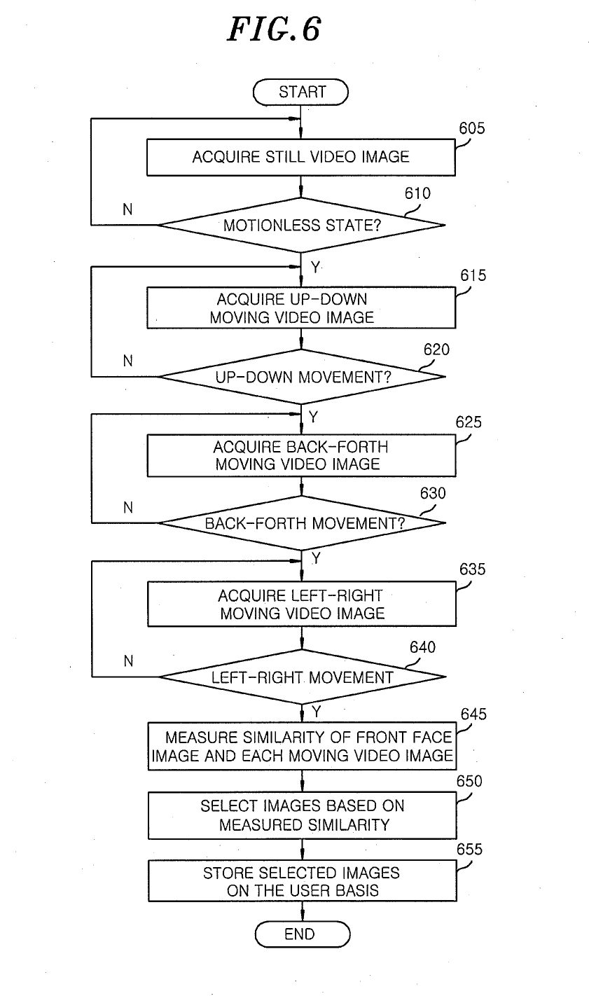

FIG. 6 is a flowchart illustrating a face image registration method in accordance with an embodiment of the present invention.

Referring to FIG. 6, the face image registration method begins with block 605 to acquire the still video image of the face of the user and extract the front face image from the still video image.

Thereafter, in block 610, it is determined that the pose change in the acquired still video image is the motionless state by checking the pose change of the user based on the acquired still video image. The method for determining the face pose change may include, for example, a method in which feature points are extracted from the eye, nose, mouth, and the like of the face in the respective video images, a face pose is estimated based on the correlation of the feature points, and a full movement is determined through the pose estimation of the respective video images; and a method in which feature points such as of the face in the respective video images are traced to determine the face movement. However, these methods are merely examples and the method is not limited thereto.

Next, when the pose change in the acquired picture image is the motionless state as the determination results in block 610, the up-down moving video image is acquired in block 615.

Subsequently, it is determined that the pose change in the acquired up-down moving video image matches the up-down movement state by checking the pose change of the user based on the acquired up-down video image in block 620. As the determination result, when the pose change matches the up-down movement state, the back-forth moving video image is then acquired in block 625.

It is determined that the pose change in the acquired back-forth moving video image matches the back-forth movement state by checking the pose change of the user based on the acquired back-forth video image in block 630. As the determination result, when the pose change matches the back-forth movement state, the left-right moving video image is then acquired in block 635.

After that, it is determined that the pose change in the acquired left-right moving video image matches the left-right movement state by checking the pose change of the user based on the acquired left-right video image in block 640. As the determination result, when the pose change matches the left-right movement state, the similarity between the front video image and each of the moving video images are measured in block 645.

In block 650, one or more images are selected from the acquired moving video images based on the measured similarities. In this case, the image selection may be made in consideration of a face size, visibility, or the like of the respective video images, in addition to the similarity.,

Next, the selected one or more video images and the acquired front video image are stored on the user basis in block 655.

Meanwhile, when the pose change does not match the motionless state (i.e., any other movement except the motionless is included in the acquired still video image) as a determination result in block 610, the method returns to block 605 to reacquire another still video image.

Also, when the pose change does not match the up-down movement state (any other movement other than the up-down movement is included in the acquired up-down moving video image) as a determination result in block 620, the method returns to block 615 to reacquire another up-down moving video image.

Also, when the pose change does not match the back-forth movement state (any other movement other than the back-forth movement is included in the acquired back-forth moving video image) as a determination result in block 630, the method returns to block 635 to reacquire another back-forth moving video image.

Also, when the pose change does not match the left-right movement state (any other movement other than the left-right movement is included in the acquired left-right moving video image) as a determination result in block 640, the method returns to block 635 to reacquire another left-right moving video image.

Meanwhile, though not shown in drawings, the face image registration method may further include an operation (not shown) to produce a guiding signal to induce the pose change of the user and provide it to the user before performing the operations in blocks 605, 615, 625 and 635.

In accordance with an embodiment of the present invention, therefore, it is possible to improve the face recognition performance by inducing a change in a face pose to acquire a plurality of moving video images and storing some or all of the moving video images on the user basis based on the similarity to a front face image to utilize a face recognition technique.

As set forth above, the present invention has been investigated for the embodiments. It will be understood by those skilled in the art that the embodiments of the present invention may be implemented in a modified form within the scope without departing from the essential features of the invention. Therefore, the disclosed embodiments need to be considered as a descriptive sense instead of not a limited sense. Therefore, the scope of the present invention should be construed as defined in the following claims rather than the aforementioned description, and all of changes and modifications that fall within equivalents are intended to be embraced by the scope of the claims of the present invention.

What is claimed is:

1. A face image registration apparatus comprising:
a face video image acquiring unit configured to acquire a front face image and one or more moving video images corresponding to predefined face pose changes;
a similarity measurement unit configured to measure a similarity of the acquired front face image and each of the acquired one or more moving video images;
an image selection unit configured to select images from the one or more moving video images based on the measured similarities; and
an image storage unit configured to store the selected one or more images on the user basis.

2. The face image registration apparatus of claim wherein the image selection unit is configured to select a preset number of images having high similarity in order.

3. The face image registration apparatus of claim 1, wherein the image selection unit is configured to select one or more images from the acquired one or more moving video images based on the measured similarities and the face visibility in the respective images.

4. The face image registration apparatus of claim 1, further comprising:
a pose change determination unit configured to determine the face pose change based on the acquired one or more moving video images; and
a control unit configured to control so that the face image acquisition unit can reacquire another front face image or one or more moving video images when the acquired front face image or the acquired moving video images do not have the predefined face pose changes.

5. A face image registration method comprising:
acquiring a front face image and one or more moving video images corresponding to face pose changes;
measuring a similarity of the acquired front face image and each of the required one or more moving video images;
selecting one or more images from the one or more moving video images based on the measured similarities; and
storing the selected one or more images on the user basis.

6. The face image registration method of claim 5, wherein said selecting one or more images comprising:
selecting a preset number of images having high similarity in order.

7. The face image registration method of claim 5, wherein said selecting one or more images comprising:
selecting one or more images from the acquired one or more moving video images based on the measured similarities and the face visibility in the respective images.

8. The face image registration method of claim 5, further comprising:
determining the face pose change based on the acquired one or more moving video images; and
controlling to reacquire another front face image or one or more moving video images when the acquired front face image or the acquired moving video images do not have the predefined face pose changes.

9. An apparatus for inducing a pose change for face image registration, the apparatus comprising:
a guiding signal producing unit configured to produce a guiding signal to induce the pose change of a user corresponding to predefined pose changes; and
a guiding signal provision unit configured to provide the produced guiding signal to the user as output.

10. An apparatus for recognizing face images, the apparatus comprising:
a pose change inducing module configured to produce a guiding signal for inducing a face pose change of the user and to provide it to the user;
a face registration module configured to acquire one or more moving video images depending on the face pose change of the user, measure the similarity to a front face image of the user, select one or more images from the acquired moving video images based on the measured similarity, and store the selected moving video images on the user basis; and
a face recognition module configured to compare a face image which is subjected to face recognition with each of the moving video images on the user basis stored in the face registration module to perform the face recognition.
